(19) United States
(12) Patent Application Publication
(10) Pub. No.: US 2022/0131860 A1
(43) Pub. Date: Apr. 28, 2022

(54) Method of authenticating terminal equipment using ARP

(71) Applicant: Chih-Fu Hwang, Taipei (TW)

(72) Inventor: Chih-Fu Hwang, Taipei (TW)

(21) Appl. No.: 17/385,066

(22) Filed: Jul. 26, 2021

(30) Foreign Application Priority Data
Oct. 23, 2020 (TW) 109136961

(51) Int. Cl. H04L 29/06; H04L 29/12

(52) U.S. Cl. CPC H04L 63/0876; H04L 61/103; H04L 63/101

(57) ABSTRACT

A method of authenticating terminal equipment using ARP is provided and tied to a network terminal equipment authentication system for 802.1X authentication. The method includes using the SU to scan ARP packets transmitted from units of TL to obtain an MAC address associated with a predetermined unit of TL, checking and modifying a terminal equipment record authorization MAC address list in the OU to add or delete an MAC address of the predetermined unit of TL, and authorizing the MIG to store a terminal equipment record authorization MAC address list in the OU of the RS to update data in the RS in real time.

### BACKGROUND OF THE INVENTION

### 1. Field of the Invention

The invention relates to a method of authenticating terminal equipment using ARP (Address Resolution Protocol) and more particularly to a method of authenticating terminal equipment by accessing a terminal equipment MAC address over a local area network.

### 2. Description of Related Art

RADIUS (Remote Authentication Dial-In User Service) is often the back-end of choice for 802.1X authentication. A RADIUS server employs an MAC (media access control) address to authenticate data input. It involves manually checking MAC address of a computer device connected to the Internet, and inputting authorized MAC address to a computer host of an authentication system. However, it is a time consuming process. Further, it can compromise the authentication system due to typographical error or erroneous data input.

Thus, the need for improvement still exists.

### SUMMARY OF THE INVENTION

It is therefore one object of the invention to provide a method for operating a network terminal equipment separation system for 802.1X authentication including a plurality of units of terminal equipment (TL), a network switch (SW), a master server (MS), an authentication server (RS), and an MAC address information gathering device (MIG) wherein the units of TL, the MS, the RS, and the MIG respectively are connected to the SW over the Internet, thereby forming a local area network (LAN), data communications are carried out over the LAN using ARP, and the MIG includes a scanning unit (SU), a data collecting unit (CU), and a data output unit (OU), the method comprising the steps of using the SU to scan a plurality of ARP packets transmitted from the units of TL wherein both an IP address and an MAC address associated with a predetermined TL are obtained by decoding the packets' raw data, and the SU stores both the IP address and the MAC address in a terminal equipment address scanning record in the CU; authorizing a system manager to access the CU over the LAN wherein the system manager accesses the terminal equipment address scanning record in the CU and checks the MAC address associated with a predetermined unit of TL over the LAN, and the system manager determines whether the MAC address is an authorized MAC address or not; authorizing the system manager to assign an unauthorized MAC address in the terminal equipment address scanning record as an authorized MAC address, and delete either the unauthorized MAC address in the terminal equipment address scanning record or the authorized MAC address in the terminal equipment address scanning record wherein the system manager saves an updated terminal equipment address scanning record as a terminal equipment record authorization MAC address list and stores same in the OU, and the IP address associated with the deleted MAC address is deleted; authorizing the MIG to access the RS over the LAN wherein the MIG stores the terminal equipment record authorization MAC address list as a data transfer record authorization MAC address list in the RS to either update data in the RS in real time or connect the RS to the OU over the LAN, accesses the terminal equipment record authorization MAC address list in the OU, and stores same as a data transfer record authorization MAC address list in the RS to update data in the RS in real time; and authorizing the RS to determine whether the MAC address associated with the predetermined unit of TL is the authorized MAC address or not based on the data transfer record authorization MAC address list and further determine the right of transferring data over the LAN of the predetermined unit of TL wherein the RS is authorized to reject or block the predetermined unit of TL associated with the unauthorized MAC address from accessing data or transferring data over the LAN.

The above and other objects, features and advantages of the invention will become apparent from the following detailed description taken with the accompanying drawings.

### BRIEF DESCRIPTION OF THE DRAWINGS

FIG. 1 is a block diagram of a system of the invention.

### DETAILED DESCRIPTION OF THE INVENTION

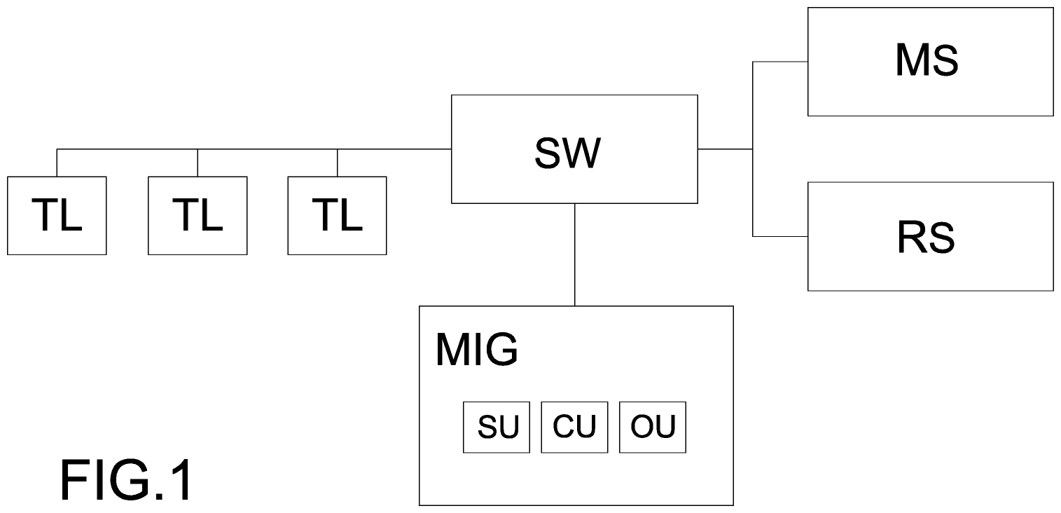

Referring to FIG. 1, it is a block diagram of a system of the invention tied to a method of authenticating terminal equipment using ARP according to a first preferred embodiment of the invention. The system is implemented as a network terminal equipment authentication system for 802.1X authentication comprising a plurality of units of terminal equipment (TL), a network switch (SW), a master server (MS), an authentication server (RS) and an MAC address information gathering device (MIG). The units of TL, the MS, the RS, and the MIG are respectively connected to the SW over the Internet, thereby forming a local area network (LAN). Data communications are carried out over the LAN using ARP. The MIG includes a scanning unit (SU), a data collecting unit (CU) and a data output unit (OU). The SU is used to scan a plurality of ARP packets transmitted from the units of TL. Both Internet Protocol (IP) address and MAC address associated with a predetermined unit of TL are obtained by decoding the packet's raw data. Then the SU stores the IP address and the MAC address in a terminal equipment address scanning record which is in turn stored in the CU.

A system manager can access the CU over the LAN. Next, the system manager can access the terminal equipment address scanning record in the CU and check the MAC address associated with a predetermined TL over the LAN. Thus, the system manager can determine whether the MAC address is the authorized MAC address. The system manager can assign the unauthorized MAC address in the terminal equipment address scanning record as an authorized MAC address, delete the unauthorized MAC address in the terminal equipment address scanning record, or delete the authorized MAC address in the terminal equipment address scanning record. Next, the system manager can save the updated terminal equipment address scanning record as a terminal equipment record authorization MAC address list and store same in the OU. The IP address associated with the deleted MAC address is also deleted.

The MIG can access the RS over the LAN. The MIG next stores the terminal equipment record authorization MAC address list as a data transfer record authorization MAC address list which is in turn stored in the RS. Thus, data in the RS is updated in real time. The RS can determine whether the MAC address associated with the TL is the authorized MAC address based on the data transfer record authorization MAC address list and further determine the right of transferring data over the LAN by the TL. The RS can reject or block the TL associated with the unauthorized MAC address from accessing data or transferring data over the LAN.

Referring to FIG. 1, it is a block diagram of a system of the invention tied to a method of authenticating terminal equipment using ARP according to a second preferred embodiment of the invention. The system is implemented as a network terminal equipment authentication system for 802.1X authentication. The network terminal equipment authentication system for 802.1X authentication comprises a plurality of units of TL, an SW, an MS, an RS and an MIG. The units of TL, the MS, the RS, and the MIG are respectively connected to the SW over the Internet, thereby forming an LAN. Data communications are carried out over the LAN using ARP. The MIG includes an SU, a CU and an OU. The SU is used to scan a plurality of ARP packets transmitted from the units of TL. IP address and MAC address associated with a predetermined TL are obtained by decoding the packet's raw data. Then the SU stores the IP address and the MAC address in a terminal equipment address scanning record which is in turn stored in the CU.

A system manager can access the CU over the LAN. Next, the system manager can access the terminal equipment address scanning record in the CU and check the MAC address associated with a predetermined TL over the LAN. Thus, the system manager can determine whether the MAC address is the authorized MAC address. The system manager can assign the unauthorized MAC address in the terminal equipment address scanning record as an authorized MAC address, delete the unauthorized MAC address in the terminal equipment address scanning record, or delete the authorized MAC address in the terminal equipment address scanning record. Next, the system manager can save the updated terminal equipment address scanning record as a terminal equipment record authorization MAC address list and store same in the OU. The IP address associated with the deleted MAC address is also deleted.

The RS is authorized to connect to the OU over the LAN, and access the terminal equipment record authorization MAC address list stored in the OU and store same as a data transfer record authorization MAC address list in the RS. Thus, data in the RS is updated in real time. The RS can determine whether the MAC address associated with the TL is the authorized MAC address based on the data transfer record authorization MAC address list and further determine the right of transferring data over the LAN by the TL. The RS can reject or block the TL associated with the unauthorized MAC address from accessing data or transferring data over the LAN.

It is envisaged by the invention that the MIG employs contents of an ARP packet to access an MAC address and an IP address associated with a unit of terminal equipment and the system manager is allowed to view, set or modify data and update data of the RS in real time. Thus, the RS can reject or block the TL associated with the unauthorized MAC address from accessing data or transferring data over the LAN.

Further, the invention can solve the conventional problem of being time consumed by checking, verifying and confirming an MAC address, and establishing an MAC address list manually, and compromising the authentication system due to typographical error or erroneous data input.

Furthermore, the invention can help a system manager determine whether a unit of terminal equipment is a unit of authorized terminal equipment by checking whether there is an IP address or a host in an automatically created data file. It is not a conventional authentication method which involves using a system authentication host to authenticate a username and a password of a terminal equipment user.

It is further envisaged by the invention that the method eliminates conventional manual check, verification and determination of MAC address of a terminal equipment and manual creation of MAC address list both being time consuming and error prone. It is further envisaged by the invention that the method can record IP address or host name in data of an automatically created file, enable a system manager to authenticate whether a unit of terminal equipment is an authorized unit of terminal equipment. This is a contrast to the conventional method of authenticating a unit of terminal equipment by a host by verifying inputted username and password. As a result, information safety of the Intranet is greatly increased.

While the invention has been described in terms of preferred embodiments, those skilled in the art will recognize that the invention can be practiced with modifications within the spirit and scope of the appended claims.

What is claimed is:

1. A method for operating a network terminal equipment separation system for 802.1X authentication including a plurality of units of terminal equipment (TL), a network switch (SW), a master server (MS), an authentication server (RS), and an MAC address information gathering device (MIG) wherein the units of TL, the MS, the RS, and the MIG respectively are connected to the SW over the Internet, thereby forming a local area network (LAN), data communications are carried out over the LAN using ARP, and the MIG includes a scanning unit (SU), a data collecting unit (CU), and a data output unit (OU), the method comprising the steps of:
using the SU to scan a plurality of ARP packets transmitted from the units of TL wherein both an IP address and an MAC address associated with a predetermined TL are obtained by decoding the packets' raw data, and the SU stores both the IP address and the MAC address in a terminal equipment address scanning record in the CU;
authorizing a system manager to access the CU over the LAN wherein the system manager accesses the terminal equipment address scanning record in the CU and checks the MAC address associated with a predetermined unit of TL over the LAN, and the system manager determines whether the MAC address is an authorized MAC address or not;
authorizing the system manager to assign an unauthorized MAC address in the terminal equipment address scanning record as an authorized MAC address, and delete either the unauthorized MAC address in the terminal equipment address scanning record or the authorized MAC address in the terminal equipment address scanning record wherein the system manager saves an updated terminal equipment address scanning record as a terminal equipment record authorization MAC address list and stores same in the OU, and the IP address associated with the deleted MAC address is deleted;
authorizing the MIG to access the RS over the LAN wherein the MIG stores the terminal equipment record authorization MAC address list as a data transfer record authorization MAC address list in the RS to either update data in the RS in real time or connect the RS to the OU over the LAN, accesses the terminal equipment record authorization MAC address list in the OU, and stores same as a data transfer record authorization MAC address list in the RS to update data in the RS in real time; and
authorizing the RS to determine whether the MAC address associated with the predetermined unit of TL is the authorized MAC address or not based on the data transfer record authorization MAC address list and further determine the right of transferring data over the LAN of the predetermined unit of TL wherein the RS is authorized to reject or block the predetermined unit of TL associated with the unauthorized MAC address from accessing data or transferring data over the LAN.
